(19) United States
(12) Patent Application Publication
(10) Pub. No.: US 2025/0382156 A1
(43) Pub. Date: Dec. 18, 2025

(54) ELEVATOR CAR AND ELEVATOR ASSEMBLY

(71) Applicant: Otis Elevator Company, Farmington, CT (US)

(72) Inventor: Gilles Bruno, Chateauneuf Sur Loire (FR)

(21) Appl. No.: 19/236,175

(22) Filed: Jun. 12, 2025

(30) Foreign Application Priority Data
Jun. 14, 2024 (EP) 24305941.7

(51) Int. Cl. B66B 11/02

(52) U.S. Cl. CPC B66B 11/0246

(57) ABSTRACT

An elevator car (1) defining an interior space (4) for accommodating passengers and/or cargo. The elevator car (1) includes a working platform (8) moveable up and down within the interior space (4), and pull means (10) mounted to the elevator car (1) above the interior space (4) and connected to the working platform (8) for moving the working platform (8) between a stowed position and a lowered position and holding the working platform (8) at an operational position. The pull means (10) includes a retracting mechanism. A retracting force of the retracting mechanism is set to compensate for the weight of the working platform (8) or less.

### FOREIGN PRIORITY

This application claims priority to European Patent Application No. 24305941.7, filed Jun. 14, 2024, and all the benefits accruing therefrom under 35 U.S.C. § 119, the contents of which in its entirety are herein incorporated by reference.

### TECHNICAL FIELD OF INVENTION

The disclosure relates to an elevator car having a working platform and pull means for moving and holding the working platform, and an elevator assembly having an elevator shaft and the elevator car.

### BACKGROUND OF THE INVENTION

It is known to provide a working platform located in an elevator car defining an interior space. The working platform is moveable between a stowed position and a lowered position. In an operational position, the working platform is located within the elevator car, at such a height that a maintenance person is able to stand on the working platform and to access elevator components through an opening in a ceiling of the elevator car. This often requires the maintenance person to exert a large amount of force on the working platform to push it back up to the stowed position, and to be careful when lowering the working platform to prevent a sudden drop or freefall of the working platform. For this reason, the working platform is moved and held by using a support structure comprising a scissors mechanism.

In this respect, it is an object of the present disclosure to provide an improved technique for an elevator car having a working platform. More specifically, the present disclosure should be applicable for elevator cars with different car sizes.

This is solved by an elevator car and an elevator assembly according to the independent claims. Preferred embodiments are subject matter of the dependent claims.

### SUMMARY OF THE INVENTION

According to an aspect an elevator car defines an interior space for accommodating passengers and/or cargo. The elevator car can define an interior space in the shape of a cuboid, or an oval or round cylinder. The elevator car can have a floor, a ceiling and multiple side walls, at least one of which may include an elevator door, in order to define the interior space. The elevator car can have at least one elevator car frame structure. The elevator car comprises a working platform. The working platform is moveable up and down within the interior space. The working platform can be a portion of the ceiling or can be the complete ceiling. The working platform can be shaped as a rectangle, an oval or a circle. The elevator car comprises pull means mounted to the elevator car above the interior space and connected to the working platform for moving the working platform between a stowed position (can also be referred to as an upper position) and a lowered position and holding the working platform at an operational position. The operational position can be between the stowed position and the lowered position. For example, the pull means can be mounted on top of an elevator car frame arranged around an upper end of the elevator car. The pull means can reach through an opening defined by the elevator car frame into the interior space for moving and holding the working platform. The stowed position can be located within the elevator car frame. That is, the working platform can be located within the elevator car frame in the stowed position. The pull means comprises a retracting mechanism. A retracting force of the retracting mechanism is set to compensate for the weight of the working platform or less. The retracting mechanism can comprise a spring mechanism for generating the retracting force. That is, a spring return force of the spring mechanism can correspond to the retracting force. In this way, the retracting mechanism prevents the working platform from falling down rapidly when lowering the working platform from the stowed position. Consequently, a risk of injury, e.g. head injury, is avoided or at least reduced. In addition, the working platform can be brought back into the stowed position easily with little force.

According to an aspect the pull means can comprise a self-blocking mechanism configured to prevent movement of the pull means when a specific activation force towards the lowered position is exceeded. Therefore, a movement of the working platform towards the lowered position is blocked or stopped in case the working platform is moved with too much force, i.e. too fast.

According to an aspect a length of the pull means can be set in accordance with the lowered position such that the operational position corresponds to the lowered position. The pull means can omit any fixing mechanism which allows that the working platform is held in a position between the upper position and the lowered position. In this way, only the lowered position can be set as the operational position. For example the length of the pull means can be adjusted so that the working platform is between 0.9 to 1.1 m, specifically 1.0 m, below an upper end of the elevator car. The upper end of the elevator car then forms a balustrade for a person standing on the working platform. Consequently, safety requirements regarding elevator car maintenance are met.

According to an aspect the working platform comprises a self-locking mechanism configured to automatically engage with the elevator car when the working platform is in the stowed position. For example, the self-locking mechanism can engage with the elevator car frame arranged on an upper end of the elevator car. By using the self-locking mechanism the working platform is restricted from unintentionally moving towards the lowered position.

According to an aspect the self-locking mechanism is a snap action mechanism and/or a latch. A recess for the snap action mechanism and/or the latch can be formed in the elevator car, in particular the elevator car frame. In this way, the working platform can be securely stowed in the stowed position.

According to an aspect the pull means can comprise at least one belt reel and a corresponding belt. The pull means can for example comprise two, three, four, five, six or any other natural number of belt reels with corresponding belts. In this case the retracting mechanism can be included in the belt reels. Since belts can be rolled in a compact manner, the pull means only requires a small space. Further, compared to wires or cables, a risk of entanglement can be reduced by using belts.

According to an aspect the working platform can comprise a lateral movement restriction mechanism. In this way, swivelling of the working platform in the operational position, e.g. the lowered position, can be avoided or limited.

According to an aspect the lateral movement restriction mechanism is configured to avoid any movement in the lateral direction. The lateral movement restriction mechanism can be formed by multiple parts. The lateral movement restriction mechanism can be engaged with the working platform and with other parts of the elevator car, for example the side walls and/or the elevator car frame. The lateral movement restriction mechanism can comprise a screwing mechanism, a sliding part and/or a rotating part. The lateral movement restriction mechanism can be configured such that it avoids damage of the other parts of the elevator car frame. For example, the lateral movement restriction mechanism can be arranged in a gap between the working platform and the other parts of the elevator car, i.e. the side walls and/or the elevator car frame. In this way, swivelling of the working platform can be completely avoided.

According to an aspect the lateral movement restriction mechanism can be removably attachable to the working platform. For example, the lateral movement restriction mechanism can be attached to corners and/or edges of the working platform. In particular, the lateral movement restriction mechanism can be at least one foam block. For example, two foam blocks can be inserted into gaps between the working platform and the other parts of the elevator car, i.e. the side walls and/or the elevator car frame, on two opposing sides of the working platform. Accordingly, the lateral movement restriction mechanism can be attached when the working platform is in the operational position, e.g. the lowered position. In this way, the working platform can be easily moved to the operational position and can then be secured against swivelling by installing the lateral movement restriction means.

According to an aspect a pull/push mechanism can be attached or attachable on a lower side of the working platform and can be configured for pushing the working platform towards the stowed position and pulling the working platform towards the lowered position. The pull/push mechanism can be a handle attached to the lower side of the working platform. The pull/push mechanism can be an eyelet attached to the lower side of the working platform and a hook, which can be engaged with the eyelet. The eyelet can be even formed by the handle. This allows the platform to be manoeuvred into the lowered position or the stowed position in a controlled manner.

According to an aspect a telescopic or foldable ladder can be stored on an upper side of the working platform. A maintenance person can use the ladder to ascent on the working platform, which has been moved to the operational position, e.g. the lowered position, in order to perform maintenance work above the elevator car. When placing the ladder on the floor, a resistance of the working platform to swivelling is improved.

According to an aspect the ladder is pivotable around an edge of the working platform. In this way, installation of the ladder is facilitated.

According to an aspect a decorative ceiling can be removably attached or attachable above the interior space and below the working platform, which is in the stowed position. In this way, the working platform can be concealed behind the decorative ceiling and the optical appearance of the interior space can be defined by the decorative ceiling.

According to an aspect the decorative ceiling can be pivotable with respect to the working platform. For example, one edge of the decorative ceiling can be mounted to the elevator car or the elevator car frame by means of at least one hinge. In this way, detachment of the decorative ceiling is facilitated when the working platform is to be used.

According to an aspect the elevator car cannot comprise a scissors mechanism for moving and holding the working platform. This means, the elevator car, i.e. the pull means, can omit arms, bearings and/or hinges. In this way, a complex and expensive structure for moving and holding the working platform can be avoided.

According to an aspect an elevator assembly comprises an elevator shaft and the elevator car according to the previous aspects. Consequently, the retracting mechanism avoids the working platform from falling down rapidly in the elevator car when lowering the working platform from the stowed position towards the lowered position. Consequently, a risk of injury, e.g. head injury, is avoided or at least limited. In addition, the working platform can be moved into the stowed position with little force.

### BRIEF DESCRIPTION OF THE DRAWINGS

Embodiments of the present disclosure, as an example only, will be described in the following with reference to the drawings. In the drawings:

FIG. 1 shows a cross-section view of an elevator assembly having an elevator shaft and an elevator car, in which a working platform is lowered from a stowed position towards a lowered position; and

FIG. 2 shows a cross-section view of the elevator assembly rotated by 90 degrees compared to FIG. 1, wherein the working platform is in the lowered position.

### DETAILED DESCRIPTION OF THE INVENTION

In the following, embodiments of the present disclosure are explained with reference to the drawings. The same elements are assigned the same reference numbers in the drawings. It is to be noted, that the embodiments are described for exemplary purposes only and the description of the embodiments is not intended to limit the scope of the present disclosure.

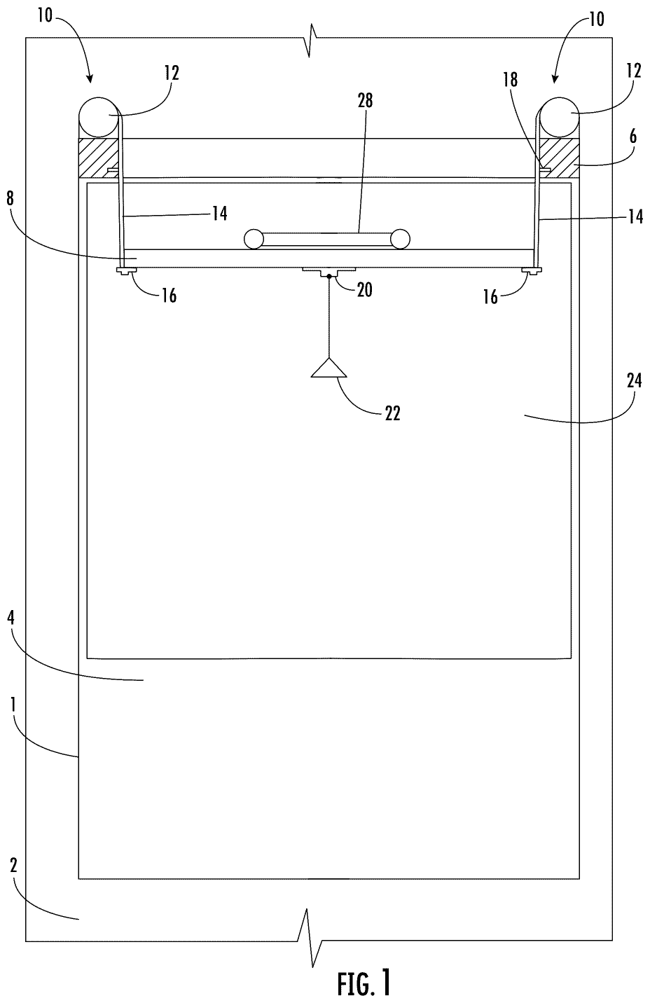

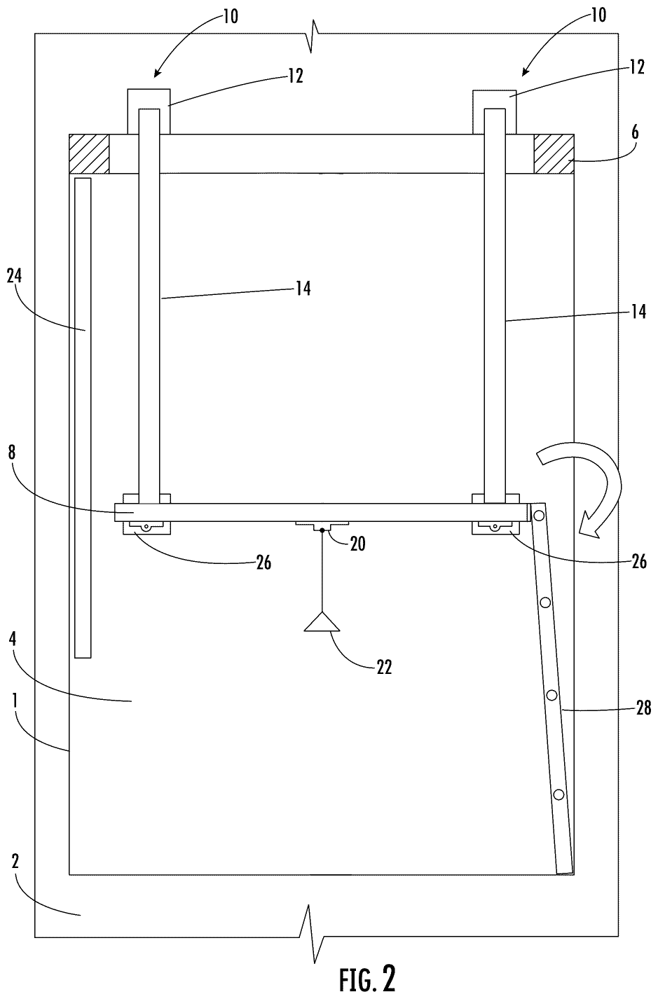

FIG. 1 shows a cross-section view of an elevator assembly having an elevator car 1 movable up and down inside an elevator shaft 2. FIG. 2 shows another cross-section view of the elevator assembly rotated by 90 degrees compared to FIG. 1.

As shown in FIGS. 1 and 2, the elevator car 1 defines an interior space 4 in the shape of a cuboid for accommodating passengers and/or cargo. For this purpose, the elevator car 1 has a floor, a ceiling and multiple side walls, at least one of which may include an elevator door. In some embodiments, the elevator car 1 can have the shape of an oval or round cylinder. On a top end of the elevator car 1, i.e. above the interior space 4, the elevator car 1 can have an elevator car frame 6. In FIGS. 1 and 2, only a top frame of the elevator car frame 6 is shown. In some embodiments, the elevator car 1 can only comprise the top frame.

The elevator car 1 comprises a working platform 8. The working platform 8 is moveable up and down within the interior space 4. In FIG. 1, the working platform 8 is a portion of the ceiling and is shaped as a rectangle. In some embodiments, the working platform 8 can be round or oval.

For moving the working platform 8 between a stowed position (can also be referred to as an upper position) and a lowered position and holding the working platform 8 at an operational position, the elevator car 1 comprises pull means 10. The pull means 10 are mounted to the elevator car, in the present embodiment to the elevator car frame 6, above the interior space 4 and are connected to the working platform 8.

In the present embodiment, the pull means 10 comprises four belt reels 12 and corresponding belts 14. In FIGS. 1 and 2 only two belt reels 12 and two belts 14 are shown due to perspective reasons. However, the number of belt reels 12 and belts 14 is not limited to four, and the pull means 10 can have for example two, three, five six or any other natural number of belt reels. As can be seen in FIGS. 1 and 2, the belt reels 12 are mounted on top of the elevator car frame 6 and the belts 14 reach through an opening defined by the elevator car frame 6 into the interior space 4. In the present embodiment, the stowed position is located within the elevator car frame 6. That is, the working platform 8 is arranged within the elevator car frame 6 when it is in the stowed position.

The working platform 8 has a self-locking mechanism configured to automatically engage with the elevator car frame 6 when the working platform 8 is in the stowed position. In the present embodiment, the self-locking mechanism is a snap action mechanism 16 which engages with a recess 18 in the elevator car frame 6. In some embodiments, the self-locking mechanism can comprise a latch, which can be manually slid into the recess 18 formed in the elevator car frame 6 for example by moving a latch handle protruding through a slit formed in the lower side of the working platform 6 towards the recess 18.

In FIGS. 1 and 2, a pull/push mechanism is attached on a lower side of the working platform 8. By using the pull/push mechanism the working platform 8 can be pushed towards the stowed position and pulled towards the lowered position. In the present embodiment, the pull/push mechanism comprises an eyelet 20 attached to the lower side of the working platform 8 and a hook 22, which can be engaged with the eyelet 20.

FIG. 1 shows a case, in which the working platform 8 is pulled from the stowed position towards the lowered position by using the hook 22. In order to avoid the working platform 8 from falling down rapidly, the pull means 10 comprises a retracting mechanism. In the present embodiment, the retracting mechanism is included in the belt reels 12. A retracting force of the retracting mechanism is set to compensate for the weight of the working platform 8 or less. That is, the retracing force is equal to or less than the weight force of the working platform 8. The retracting mechanism can comprise a spring mechanism for generating the retracting force. That is, a spring return force of the spring mechanism corresponds to the retracting force. In addition, the pull means 10, i.e. the belt reels 12, comprise a self-blocking mechanism configured to prevent movement of the working platform 8 when a specific activation force towards the lowered position is exceeded.

As shown in FIGS. 1 and 2, a decorative ceiling 24 is removably attachable above the interior space 4 and below the working platform 8, which is in the stowed position. In the present embodiment, one edge of the decorative ceiling 24 is hingedly mounted to the elevator car frame 6 so that it is pivotable with respect to the working platform 8 stowed in the stowed position.

FIG. 2 shows a case in which the working platform 8 is in the lowered position. In the present embodiment a length of the pull means 10, i.e. the belts 14, is set in accordance with the lowered position such that the operational position corresponds to the lowered position. The pull means 10, i.e. the belt reels 12, omit any fixing mechanism which allows that the working platform 8 is held in a position between the upper position and the lowered position.

In order to avoid swivelling of the working platform 8 in the lowered position, the working platform 8 comprises a lateral movement restriction mechanism. In some embodiments, the lateral movement restriction mechanism is configured to avoid any movement in the lateral direction. In particular, the lateral movement restriction mechanism is removably attachable to the working platform 8, for example, to corners and/or edges of the working platform 8. In the present embodiment shown in FIG. 2, foam blocks 26 are removably attached to corners of the working platform 8. The foam block 26 can be carried by a maintenance person, who is to perform maintenance work on the elevator car.

The elevator car 2 comprises a telescopic or foldable ladder 28, which, as shown in FIG. 1, is storeable on an upper side of the working platform 8. After the working platform 8 is brought into the lowered position, i.e. the operational position, the ladder 28 is, as indicated by the bent arrow in FIG. 2, pivoted around an edge of the working platform 8 in order to allow the maintenance person to ascend on the working platform 8.

What is claimed is:

1. An elevator car (1) defining an interior space (4) for accommodating passengers and/or cargo, the elevator car (1) comprising:
a working platform (8) moveable up and down within the interior space (4), and pull means (10) mounted to the elevator car (1) above the interior space (4) and connected to the working platform (8) for moving the working platform (8) between a stowed position and a lowered position and holding the working platform (8) at an operational position, characterized in that the pull means (10) comprises a retracting mechanism, a retracting force of which is set to compensate for the weight of the working platform (8) or less.

2. The elevator car (1) according to claim 1, characterized in that the pull means (10) comprises a self-blocking mechanism configured to prevent movement of the pull means (10) when a specific activation force towards the lowered position is exceeded.

3. The elevator car (1) according to claim 1, characterized in that a length of the pull means (10) is set in accordance with the lowered position such that the operational position corresponds to the lowered position.

4. The elevator car (1) according to claim 1, characterized in that the working platform (8) comprises a self-locking mechanism (16, 18) configured to automatically engage with the elevator car (1) when the working platform (8) is in the stowed position.

5. The elevator car (1) according to claim 4, characterized in that the self-locking mechanism (16, 18) is a snap action mechanism (16) and/or a latch.

6. The elevator car (1) according to claim 1, characterized in that the pull means (10) comprises at least one belt reel (12) and a corresponding belt (14).

7. The elevator car (1) according to claim 1, characterized in that the working platform (8) comprises a lateral movement restriction mechanism (26).

8. The elevator car (1) according to claim 7, characterized in that the lateral movement restriction mechanism (26) is configured to avoid any movement in the lateral direction.

9. The elevator car (1) according to claim 7, characterized in that the lateral movement restriction mechanism (26) is removably attachable to the working platform (8).

10. The elevator car (1) according to claim 1, characterized by a pull/push mechanism (20, 22) being attached or attachable on a lower side of the working platform (8) and configured for pushing the working platform (8) towards the stowed position and pulling the working platform (8) towards the lowered position.

11. The elevator car (1) according to claim 1, characterized by a telescopic or foldable ladder (28) which is stored on an upper side of the working platform (8).

12. The elevator car (1) according to claim 11, characterized in that the ladder (28) is pivotable around an edge of the working platform (8).

13. The elevator car (1) according to claim 1, characterized by a decorative ceiling (24) which is removably attached or attachable above the interior space (4) and below the working platform (8), which is in the stowed position.

14. The elevator car (1) according to claim 1, characterized in that it does not comprise a scissors mechanism for moving and holding the working platform (8).

15. An elevator assembly comprising an elevator shaft (2), characterized by the elevator car (1) according to claim 1.
